(19) United States
(12) Patent Application Publication
(10) Pub. No.: US 2025/0380295 A1
(43) Pub. Date: Dec. 11, 2025

(54) METHOD AND SYSTEM FOR MASSIVE INITIAL ACCESS MANAGEMENT

(71) Applicant: Continental Automotive Technologies GmbH, Hannover (DE)

(72) Inventors: Andreas Andrae, Frankfurt am Main (DE); Rikin Shah; Reuben George Stephen, Singapore (SG); David Gonzalez Gonzalez, Egelsbach (DE); Hojin Kim, Regensburg (DE); Shravan Kumar Kalyankar, Singapore (SG); Osvaldo Gonsa, Frankfurt (DE)

(73) Assignee: Continental Automotive Technologies GmbH, Hannover (DE)

(21) Appl. No.: 18/878,697

(22) PCT Filed: Jun. 22, 2023
(86) PCT No.: PCT/EP2023/066981

§ 371 Date: Dec. 24, 2024

(30) Foreign Application Priority Data
Jun. 24, 2022 (SG) 10202250279Q
Jun. 30, 2022 (DE) 10 2022 206 736.3

(51) Int. Cl. H04W 74/00; H04W 74/0833; H04W 84/06

(52) U.S. Cl. CPC H04W 74/002; H04W 74/0833; H04W 84/06

(57) ABSTRACT

Improving random access and energy consumption of a large user equipment group in a cellular network by a lead user equipment relaying network measurements to a target network cell, receiving equipment specific random access configurations from the target network cell, and relaying the equipment specific random access configurations to the user equipment group for performing random access contention to the target network cell.

### CROSS-REFERENCE TO RELATED APPLICATIONS

The present application is a National Stage Application under 35 U.S.C. § 371 of International Patent Application No. PCT/EP2023/066981 filed on Jun. 22, 2023, and claims priority from German Patent Application No. 10 2022 206 736.3 filed on Jun. 30, 2022, and Singapore patent application Ser. No. 10/202,250279Q filed on Jun. 24, 2022, the disclosures of which are herein incorporated by reference in their entireties.

### TECHNICAL FIELD

The present application relates to cellular networks, and more particularly to a method and system for improving random access and energy consumption of a large user equipment (UE) group in a cellular network.

### BACKGROUND

Next generation wireless and cellular networks, such as fifth generation (5G) networks, may include a terrestrial network (TN) system and a non-terrestrial network (NTN) system (3GPP Rel. 18 WI: NR NTN (Non-Terrestrial Networks) Enhancements). For example, a 5G system may include a satellite based non-terrestrial network system in addition to a conventional terrestrial system.

To improve overall network coverage, non-terrestrial network systems may provide greater geographic service coverage capabilities for areas that may be underserved or unserved by conventional terrestrial network systems. Such areas may include remote geographies, difficult to access geographies, or areas over which terrestrial networks may be unable to be deployed, such as lakes and oceans.

In addition, non-terrestrial network systems may provide reduced vulnerability to infrastructure disruption, such as to physical attacks and natural disasters on terrestrial networks and systems. Moreover, non-terrestrial network systems may provide reinforced service reliability, such as service continuity for machine-to-machine (M2M) and Internet of Things (IoT) devices or for passengers on board moving platforms, such as aircrafts or vessels. Finally, non-terrestrial network systems may provide efficient multicast or broadcast for data delivery towards network edges or user terminals.

As a result, non-terrestrial network systems and components will impact coverage, user bandwidth, system capacity, service reliability or service availability, energy consumption, and connection density of the overall next generation cellular network system.

### BRIEF SUMMARY

Aspects of embodiments of the present application relate to a method and system for improving random access and energy consumption of a large user equipment (UE) group in a cellular network.

According to an aspect of an embodiment, there is provided a cellular network system including a network cell, a first user equipment connected to the network cell; and a second user equipment connected to the first user equipment via local communication protocol, wherein the first user equipment is configured to request from the network cell a random access configuration of the second user equipment, and wherein the first user equipment is configured to transmit the random access configuration to the second user equipment.

The network cell may be a network cell of a non-terrestrial network (NTN).

The random access configuration may be random access information for the second user equipment to perform random access to a terrestrial network (TN).

The second user equipment may be a plurality of user equipment.

The first user equipment may be configured to request from the network cell random access configurations of the plurality of user equipment based on a cell measurement report of the first user equipment.

The first user equipment may be configured to request from the network cell random access configurations of the plurality of user equipment based on cell measurement reports of the plurality of user equipment.

The first user equipment may be in an RRC_CONNECTED state connected to the network cell.

The plurality of user equipment may be in an RRC_INACTIVE state to the network cell.

The first user equipment may be configured to control the plurality of user equipment to obtain the cell measurement reports to perform random access to the terrestrial network (TN).

The plurality of user equipment may be configured to perform random access to the terrestrial network (TN) based on the random access information.

According to an aspect of an embodiment, there is provided a user equipment including a transceiver and a control unit configured to control the transceiver to connect the user equipment to a network cell, control the transceiver to connect to a second user equipment via local communication protocol, control the transceiver to request from the network cell a random access configuration of the second user equipment, and control the transceiver to transmit the random access configuration to the second user equipment.

The network cell may be a network cell of a non-terrestrial network (NTN).

The random access configuration may be random access information for the second user equipment to perform random access to a terrestrial network (TN).

The second user equipment may be a plurality of user equipment.

The control unit may be configured to control the transceiver to request from the network cell random access configurations of the plurality of user equipment based on a cell measurement report of the user equipment.

The control unit may be configured control the transceiver to request from the network cell random access configurations of the plurality of user equipment based on cell measurement reports of the plurality of user equipment.

The user equipment may be in an RRC_CONNECTED state connected to the network cell.

The plurality of user equipment may be in an RRC_INACTIVE state to the network cell.

The control unit may be configured to control the plurality of user equipment to obtain the cell measurement reports to perform random access to the terrestrial network (TN).

The plurality of user equipment may be configured to perform random access to the terrestrial network (TN) based on the random access information.

According to an aspect of an embodiment, there is provided a user equipment including a transceiver and a control unit configured to control the transceiver to connect the user equipment to a relay user equipment connected to network cell via local communication protocol, control the transceiver to request from the relay user equipment a random access configuration of the user equipment, and control the transceiver to connect the user equipment to a cellular network system based on the random access configuration.

The network cell may be a network cell of a non-terrestrial network (NTN).

The cellular network system may be a terrestrial network (TN), and the random access configuration comprises random access information for the user equipment to perform random access to the terrestrial network (TN).

The user equipment may be a user equipment among a plurality of user equipment connected to the relay user equipment as a group via the local communication protocol.

The control unit may be configured to control the transceiver to request the random access information based on a cell measurement report of the relay user equipment.

The control unit may be configured control the transceiver to perform a cell measurement report, and control the transceiver to request the random access information based on the cell measurement report.

The relay user equipment may be in an RRC_CONNECTED state connected to the network cell.

The user equipment may be in an RRC_INACTIVE state to the network cell.

The control unit may be configured to control the transceiver to transmit the cell measurement report to the relay user equipment.

The control unit may be configured to control the transceiver to perform random access to the terrestrial network (TN) based on the random access information.

### Technical Problem

Many industries, such as agriculture, construction, shipping, and the like, are evolving to incorporate increased levels of system and vehicle automation. This includes automated interactions between automated machinery and vehicles. Therefore, network connectivity for interconnected machinery and vehicles is likely to enable for improved operations in such industries.

Limited, insufficient, or unavailable mobile network coverage in remote areas provides a challenge to operating in some geographic environments. Integrated fifth generation (5G) non-terrestrial communications, such as Low Earth Orbit (LEO) satellites and high-altitude platforms (HAPS), can enable advanced use cases in remote areas for which conventional terrestrial-based communications are insufficient or incapable of serving.

Accordingly, automated machinery and vehicles may leverage non-terrestrial network (NTN) systems and communication to provide for connectivity. When serving a large number of devices, access attempts of a large group of user equipment (UE) may result in significant random access (RA) contention, such as when members of the group of user equipment simultaneously or substantially simultaneously attempt network access. This results in random access collisions, increased numbers of subsequent random access retries, and consequently increased processing and energy consumption on behalf of the user equipment and the network.

### Solution to Problem

In view of the above, aspects of embodiments of the present application relate to a method and system for improving random access and energy consumption of a large user equipment (UE) group in a cellular network. In particular, when a large number of devices attempt to perform network connection by random access (RA) contention, a lead device may provide device specific quality of service (QOS) profiles and cell measurement reports to a serving cell. A QoS profile is a set of parameters and meta-data characterizing user-, application-, and/or device-specific service requirements. Thereby, device specific random access configurations may be relayed from the lead device to the devices within the group. As a result, random access collisions may be avoided when the devices within the group request network access through random access contention.

### Advantageous Effects

Aspects of embodiments of the present application provide a technique for reducing the probability of random access collisions and user equipment energy consumption when requesting network access through random access contention by a lead or relay user equipment requesting and obtaining device specific random access configurations for user equipment in advance of performing the random access contention.

### BRIEF DESCRIPTION OF THE DRAWINGS

The above and other aspects will be more clearly understood from the following brief description taken in conjunction with the accompanying drawings.

FIG. 1 is a block diagram illustrating a communication network, according to an embodiment.

FIG. 2 is a sequence diagram illustrating a method of forming a group of user equipment, according to an embodiment.

FIG. 3 is a sequence diagram illustrating a method of generating network measurement reports, according to an embodiment.

FIG. 4 is a sequence diagram illustrating a method of generating user equipment specific random access configurations, according to an embodiment.

FIG. 5 is sequence diagram illustrating a method of initiating network access, according to an embodiment.

FIG. 6 is a block diagram of a user equipment, according to an embodiment.

### DETAILED DESCRIPTION

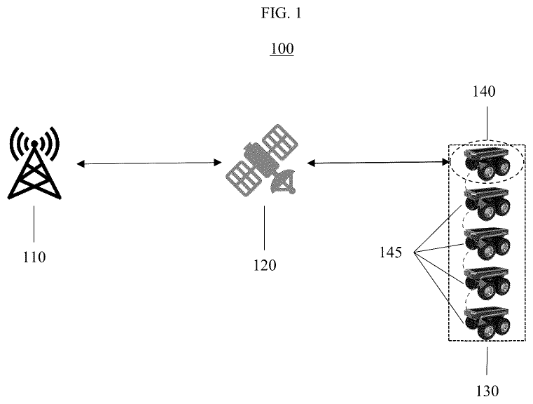

FIG. 1 is a block diagram illustrating a communication network, according to an embodiment.

As illustrated in FIG. 1, the communication network 100 includes a terrestrial network (TN) system 110, a non-terrestrial network (NTN) system 120, and a plurality of user equipment (UE) 130.

The terrestrial network system 110 may include one or more network cells or a Node B, such as a an eNodeB, a gNB, and the like.

The non-terrestrial network system 120 may include one or more Low Earth Orbit (LEO) satellites and high-altitude platforms (HAPS).

The terrestrial network 110 and the non-terrestrial network 120 of the communication network 100 may support cellular network communication according to one or more cellular communication standards, such as third generation (3G), fourth generation (4G), long term evolution (LTE), fifth generation (5G), sixth generation (6G), etc. The terrestrial network 110 and the non-terrestrial network 120 of the communication network 100 may implement wireless data communication according to one or more of Global System for Mobile Communication (GSM), General Packet Radio Service (GPRS), Universal Mobile Telephone System (UMTS), Code Division Multiple Access (CDMA), Enhanced Data for Global Evolution (EDGE), and the like.

The plurality of user equipment 130 may be a group of user equipment including a first user equipment 140, which may be referred to as a master, lead, or relay, and one or more second user equipment 145, which may be referred to as a slave, subordinate, or member.

The plurality of user equipment 130 may be embodied as a swarm of automated vehicles configured or controlled to execute one or more automated tasks of an application-specific program, such as for crop harvesting, crop seeding, and other functions associated with navigation and positional control of the plurality of user equipment 130.

The first user equipment 140 may be connected to the non-terrestrial network 120. As an example, for cost reasons, only the first user equipment 140 among the plurality of user equipment 130 may be equipped with a transceiver and an antenna system capable of performing communication with non-terrestrial network 120. Thereby, the first user equipment 140 may perform network communication via non-terrestrial network 120 and terrestrial network 110.

The first user equipment 140 may also be connected to each user equipment of the one or more second user equipment 145. The communication connection between the first user equipment 140 and the second user equipment 145 may be locally established according to one or more communication protocols such as multi-hop vehicle-to-vehicle (V2V) via WiFi, ZigBee, LoRa, Sigfox, Bluetooth or 3GPP sidelink. Accordingly, an application layer of the first user equipment 140 may control communication between the first user equipment 140 and the second user equipment 145 for coordination and control including task planning, group formation, group dissolution, and the like.

Because only the first user equipment 140 may be connected to non-terrestrial network 120, the first user equipment performs all network communication on behalf of the plurality of user equipment 130 under non-terrestrial network coverage. Therefore, the first user equipment 140 may act as a relay for the second user equipment 145 to perform network communication via non-terrestrial network 120 and terrestrial network 110.

To reduce energy consumption of the plurality of user equipment 130, although capable of communicating with terrestrial network 110, the plurality of user equipment may not be connected to terrestrial network 110 while operating in conjunction with the first user equipment 120. For example, owing to geographic range of the terrestrial network 110, the plurality of user equipment 130 may be geographically positioned outside of communication range of the terrestrial network 110. Alternatively, one or more of the first user equipment 140 and the second user equipment 145 may be controlled to be disconnected from the terrestrial network 110 for reasons of security, quality of service requirements, and the like.

In such scenarios, for example transition between non-terrestrial network coverage and terrestrial network coverage or simultaneously or substantially simultaneously under control of the application-specific program of the first user equipment 140, network access attempts of a large group of user equipment may result in significant random access (RA) contention to terrestrial network 110, which may result in an increased number of subsequent random access retries, and consequently increased energy consumption by the second user equipment 145.

To avoid random access contention to terrestrial network 110 by the plurality of user equipment 130, under direction of the application-specific program of the first user equipment 140, the second user equipment 145 may be assisted by the first user equipment 130 to establish a connection with terrestrial network 110.

Accordingly, at least one of the first user equipment 140 and the second user equipment 145 among the plurality of user equipment 130 may detect coverage of the terrestrial network 110 for individually establishing a connection with the terrestrial network 110. For example, the first user equipment 140 may be controlled to perform network detection and signal measurements of the terrestrial network 110.

Alternatively, the first user equipment 140 may control the second user equipment 145 to perform network detection and signal measurements of the terrestrial network 110. The network detection and signal measurements of the terrestrial network 110 may be transmitted from the second user equipment 145 to the first user equipment 140.

The first user equipment 140 reports the network detection and signal measurements to the terrestrial network 110, for example via non-terrestrial network 120 or directly through terrestrial network 110. In the configuration of connection to the terrestrial network 110 via the non-terrestrial network 120, the network detection and signal measurements may be forwarded by a serving cell from non-terrestrial network 120 to a target cell of terrestrial network 110 over a logical interface, such as the Xn interface for interconnection between radio access network (RAN) nodes, such as gNB, eLTE, and the like.

The network detection and signal measurements may include an identity and quantity of the plurality of user equipment 130, user equipment specific quality of service profiles, and cell measurement reports. Accordingly, the first user equipment 140 requests the terrestrial network 110 for user equipment specific random access configurations.

A serving cell of the terrestrial network 110 may provide the user equipment specific random access configurations for the plurality of user equipment 130 to the first user equipment 140. For example, the first user equipment 140 may receive the user equipment specific random access configurations from a target cell of the terrestrial network 110 via the serving cell of the non-terrestrial network 120 and a logical interface, such as the Xn interface for interconnection between radio access network (RAN) nodes, such as gNB, eLTE, and the like.

The first user equipment 140 may transmit the user equipment specific random access configurations to the second user equipment 145 over locally established communication according to one or more communication protocols such as multi-hop vehicle-to-vehicle (V2V) via WiFi, ZigBee, LoRa, Sigfox, Bluetooth or 3GPP sidelink.

As a result, each of the second user equipment 145 may establish a connection with terrestrial network 110 utilizing the user equipment specific random access configurations.

According to an embodiment, the user equipment specific random access configurations may include a random access channel (RACH) delay timer and a random access channel back-off value, in addition to an RACH preamble assignment, target cell Radio Network Temporary Identifier (C-RNTI), target data radio bearer (DRB) identifier (uplink UL/downlink DL), and a target eNodeB security algorithm, in a radio resource control (RRC) reconfiguration message. The RRC reconfiguration message may be relayed from the first user equipment 140 to the second user equipment 145. Accordingly, if a random access attempt of the second user equipment 145 fails, then a back-off corresponding to the back-off value is applied as determined by the target network cell based on priority. For example, a higher priority user equipment may be provided with a smaller back-off value and lower priority user equipment may be provided with a larger back-off value. Thereby, random access collision may be avoided.

With respect to the random access delay timer and random access back-off value, the target network may store a mapping table between a quality of service requirement and random access back-off value and the random access delay timer. For example, a user equipment with QoS1 may apply RACH delay timer D1 and back-off value B1. On the other hand, a UE2 with QoS2 may apply RACH delay timer D2 and back-off value B2. The user equipment applies the RACH delay timer and back-off values based on the QoS (and known mapping), and thereby the target network (gNB) configures QoS to user equipment through a dedicated RRC signaling message.

According to an embodiment, the first user equipment 140 proposes a user equipment specific random access configuration based on a ProSe application ID and an application layer triggered group segregation, resulting in smaller groups that are led by new relay/lead user equipment. Only a new lead user equipment is needed to perform initial access to terrestrial network.

According to an embodiment, based on specified Quality of Service (QOS) Class Identifier (QCI) mechanism (5QI), the target network (gNB) determines and broadcasts via System Information (SI) a mapping between random access occasions and required QoS (5Q1). Accordingly, the first network equipment can perform an assignment of RACH resources to remote UEs (depending on Qos profiles of the remote user equipment). Thereby, user equipment specific random access configuration may be provided from the first user equipment to the second user equipment.

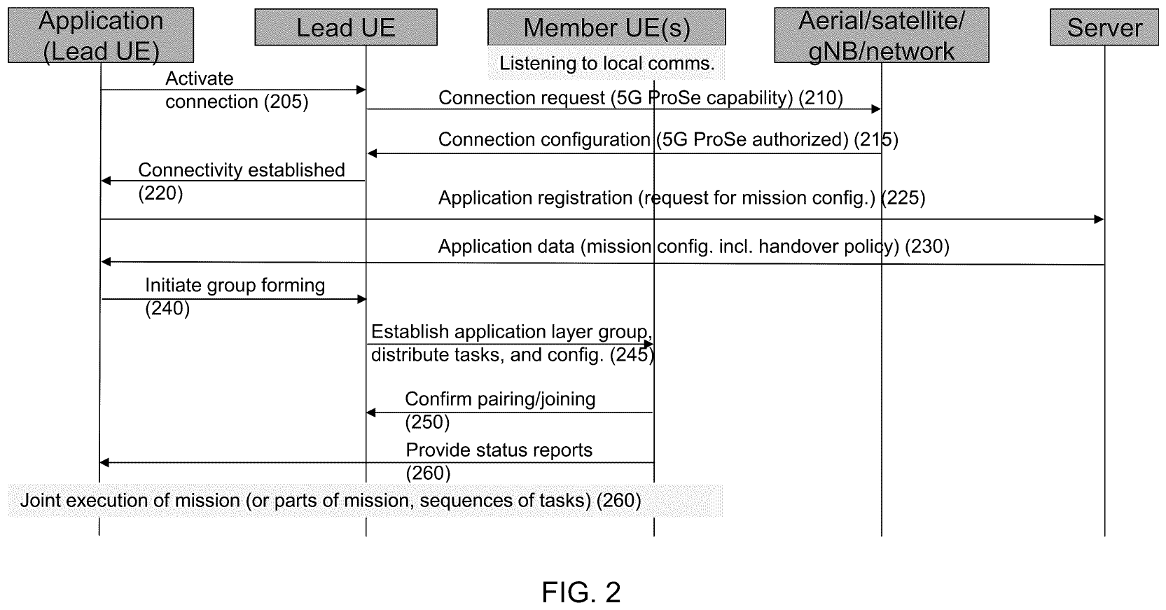

FIG. 2 is a sequence diagram illustrating a method of forming a group of user equipment, according to an embodiment.

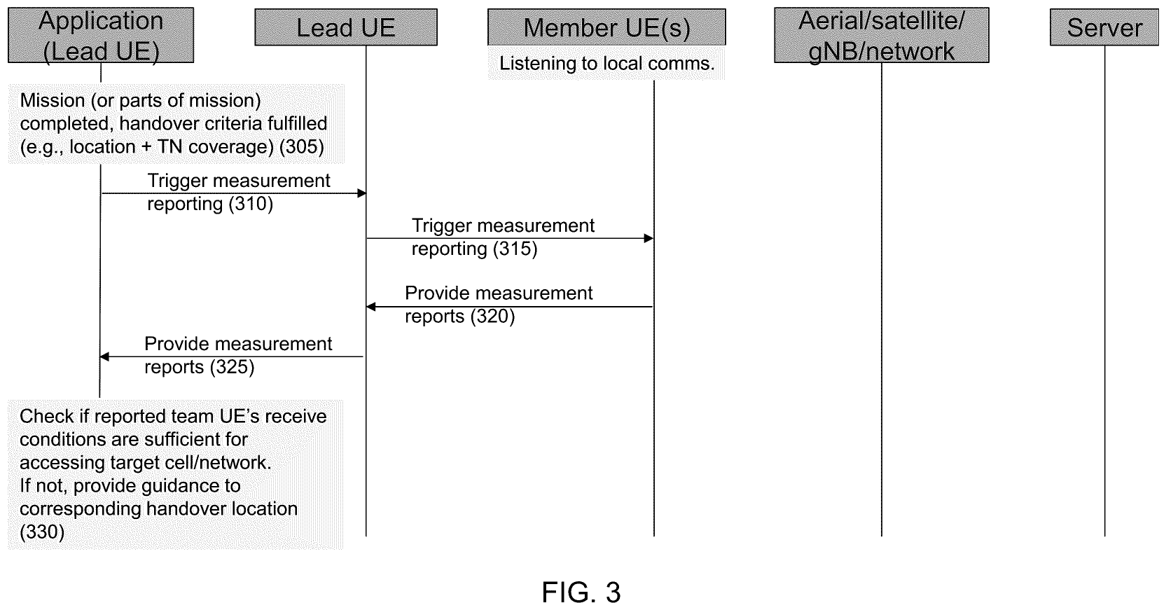

As illustrated in FIG. 2, an application may be executed by a lead user equipment. Accordingly, the embodiments address the case of “application-controlled behavior.” Alternatively, all processing may occur within the 3GPP layers, and therefore the lead user equipment can trigger a measurement report, but may also configure the member user equipment to regularly provide measurement reports, as similarly described with respect to FIGS. 2 and 3 below.

As also illustrated in FIG. 2, The lead user equipment may be the first user equipment 140 described with respect to FIG. 1. As also illustrated in FIG. 2, the lead user equipment may communicate with a member user equipment and a network. The member user equipment may be the second user equipment 145 described with respect to FIG. 1, and the network may be the non-terrestrial network 120 described with respect to FIG. 1.

In step 205, the application executed by the lead user equipment activates a connection of the lead user equipment. The application may be an application-specific program described with respect to FIG. 1 for communicating with and controlling a plurality of user equipment to execute one or more tasks.

In step 210, the lead user equipment may transmit a connection request to the network. The connection request may be performed over any suitable wireless communication protocol corresponding to communication capabilities of the network, such as cellular communication or communication to non-terrestrial infrastructure. For example, the connection request may be a connection request to establish 5G ProSe capability and ProSe authorized by the network. Accordingly, the lead user equipment may be in an RRC_CONNECTED state to the network.

In step 215, the network may transmit a connection configuration to the lead user equipment, and the lead user equipment establishes connectivity with the network in step 220. The connection configuration may indicate that the lead user equipment is 5G ProSe authorized.

In step 225, the application of the lead user equipment may transmit an application registration request to a server. The server may be associated with the application, such as for example an application host corresponding to the application. The application registration request may be a request for a set of instructions or tasks for controlling operations and positions of the lead user equipment and the member user equipment, including task schedules, vehicle or object trajectory, network preferences (e.g., NTN) during group operations and handover policy. Handover policy may be that each user equipment may be switched from a control mode in which the lead user equipment controls the member user equipment via local communication to a remote control mode in which each member user equipment is connected to the network for control via cellular network communication over the terrestrial network.

In step 230, the server may transmit application data to the lead user equipment. The application data may include a set of instructions or tasks for controlling operations and positions of the lead user equipment and the member user equipment.

In step 240, the application of the lead user equipment may initiate group formation with the member user equipment, and in step 245 the lead user equipment may transmit a request for the member user equipment to join a group of user equipment, which may correspond to the plurality of user equipment 130 described with respect to FIG. 1. The request may include a plurality of tasks and control instructions for the member user equipment to perform, as well as parameters of group communication, formation, task scheduling, and status reporting. Although the group forming is illustrated as including the distribution of tasks from the lead user equipment to the member user equipment, the artisan of ordinary skill will appreciate that the group registration and the distribution of tasks for control of the member user equipment may be separately performed.

The communication between the lead user equipment and the member user equipment may be performed over locally established communication according to one or more communication protocols such as multi-hop vehicle-to-vehicle (V2V) via WiFi, ZigBee, LoRa, Sigfox, Bluetooth or 3GPP sidelink. Accordingly, the member user equipment may be in an RRC_IDLE state to the network.

In step 250, the member user equipment transmits a confirmation or acknowledgement message to the lead user equipment confirming participation in the group.

In step 255, the member user equipment transmits a status report to the lead user equipment. The status report may include information indicating a progress of a task delegated to the member user equipment, a location of the member user equipment, and any other information indicating an operational status of the member user equipment.

Last, in step 260, the lead user equipment and the member user equipment jointly execute their corresponding tasks.

FIG. 3 is a sequence diagram illustrating a method of generating network measurement reports, according to an embodiment.

As illustrated in FIG. 3, an application may be executed by a lead user equipment. The lead user equipment may be the first user equipment 140 described with respect to FIG. 1. As also illustrated in FIG. 3, the lead user equipment may communicate with a member user equipment. The member user equipment may be the second user equipment 145 described with respect to FIG. 1.

In step 305, the lead user equipment may complete a task or operation assigned to the lead user equipment by the application of the lead user equipment. Accordingly, handover policy criteria may be triggered according to parameters of the application.

In step 310, the lead user equipment may initiate network detection and signal measurements. The lead user equipment may be in either an RRC_CONNECTED state or an RRC_INACTIVE state.

In step 315, the lead user equipment may transmit a request or provide a measurement configuration to the member user equipment to perform network detection and signal measurements. Alternatively, as discussed above, the lead user equipment may perform serving cell and neighboring cell measurements.

In steps 320 and 325, the member user equipment may perform network detection and signal measurements, and transmit results of the network detection and signal measurements to the lead user equipment.

In step 330, the lead user equipment acting as a relay node (ProSe application identifier ID) may determine whether conditions exist sufficient for the member user equipment to connect to a cell of a target network. The target network may correspond to the terrestrial network 110 described with respect to FIG. 1. If the lead user equipment determines conditions exist sufficient for the member user equipment to connect to the target network, the lead user equipment may transmit a user equipment specific random access configuration to the member user equipment. Alternatively, if the lead user equipment determines conditions do not exist for the member user equipment to connect to the target network, the lead user equipment may transmit instructions to position the member user equipment to a handover location.

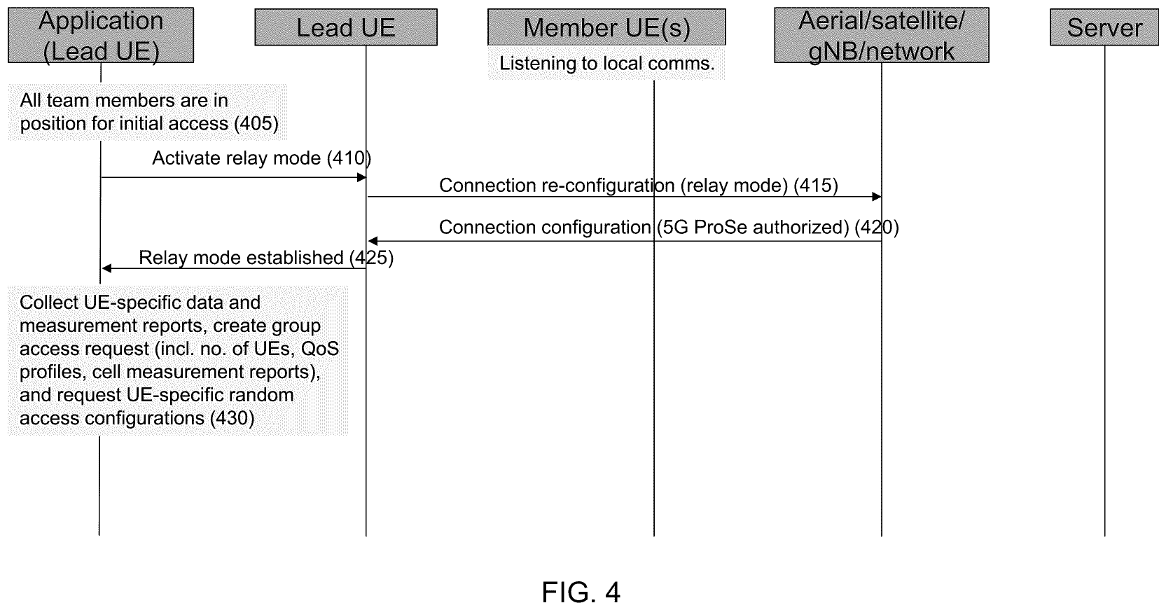

FIG. 4 is a sequence diagram illustrating a method of generating user equipment specific random access configurations, according to an embodiment.

As illustrated in FIG. 4, an application may be executed by a lead user equipment. The lead user equipment may be the first user equipment 140 described with respect to FIG. 1. As also illustrated in FIG. 4, the lead user equipment may communicate with a member user equipment and a network. The member user equipment may be the second user equipment 145 described with respect to FIG. 1, and the network may be the terrestrial network 110 or the non-terrestrial network 120 described with respect to FIG. 1.

In step 405, the application of the lead user equipment may determine that the lead user equipment and the member user equipment have completed their respective tasks and operations.

In step 410, the lead user equipment may determine to activate a relay mode. The relay mode may be a mode in which the lead user equipment may request and obtain user equipment specific random access configurations from a target network cell.

In step 415, the lead user equipment may transmit a relay mode connection request to the target network.

In step 420, the target network may transmit a connection configuration to the lead user equipment. The connection configuration may indicate that the lead user equipment is authorized to act as a 5G ProSe device.

In step 425, the relay mode may be established in the lead user equipment, and in step 430 the lead user equipment may collect user equipment specific data and measurement reports to obtain user equipment specific random access configurations from the target network cell.

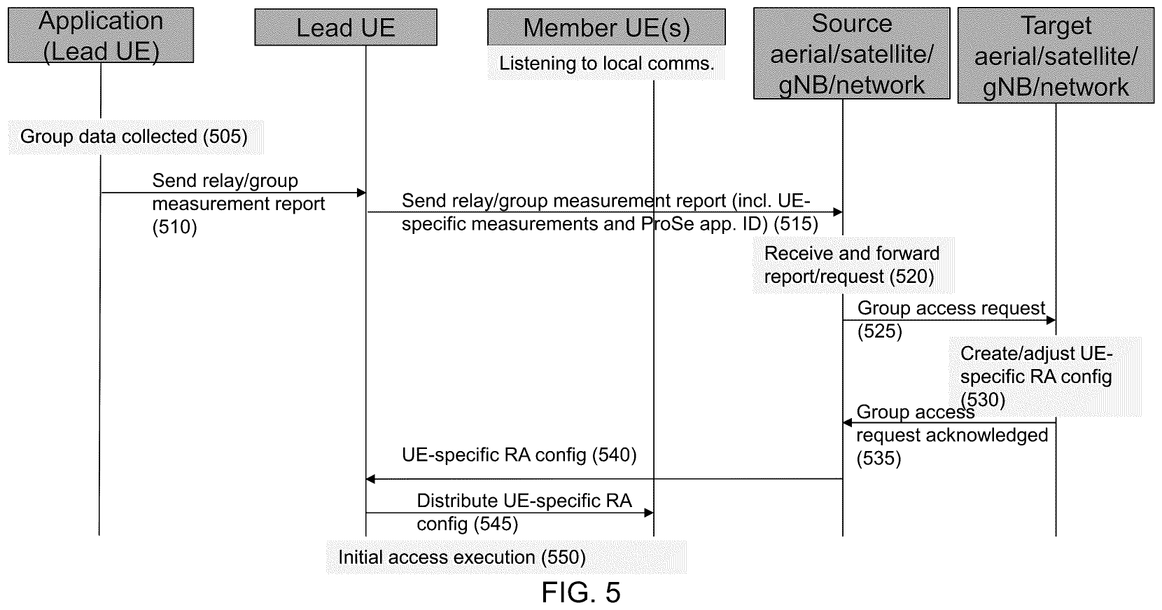

FIG. 5 is sequence diagram illustrating a method of initiating network access, according to an embodiment.

As illustrated in FIG. 5, an application may be executed by a lead user equipment. The lead user equipment may be the first user equipment 140 described with respect to FIG. 1. As also illustrated in FIG. 5, the lead user equipment may communicate with a member user equipment, a source network, and a target network. The member user equipment may be the second user equipment 145 described with respect to FIG. 1, the source network may be the non-terrestrial network 120 described with respect to FIG. 1, and the target network may be the terrestrial network 110 described with respect to FIG. 1.

In step 505, the lead user equipment may collect network detection and signal measurements of the target network from the member user equipment.

In steps 510 and 515, the lead user equipment may transmit the network detection and signal measurements to the source network. The network detection and signal measurements may include an identity and quantity of the member user equipment, member user equipment specific quality of service profiles, and cell measurement reports of the member user equipment.

In steps 520 and 525, the source network may forward the network detection and signal measurements to the target network via a logical interface, such as the Xn interface for interconnection between radio access network (RAN) nodes, such as gNB, eLTE, and the like.

In step 530, the target network receives the request for user equipment specific random access configurations corresponding to the group of member user equipment, and creates corresponding user equipment specific random access configurations.

In steps 535 and 540, the target network transmits the user equipment specific random access configurations to the lead user equipment via the source network.

In step 545, the lead user equipment transmits the user equipment specific random access configurations to the member user equipment by locally established communication according to one or more communication protocols, such as multi-hop vehicle-to-vehicle (V2V) via WiFi, ZigBee, LoRa, Sigfox, Bluetooth or 3GPP sidelink.

In step 550, the member user equipment may initiate access to the target network by random access utilizing the user equipment specific random access configurations.

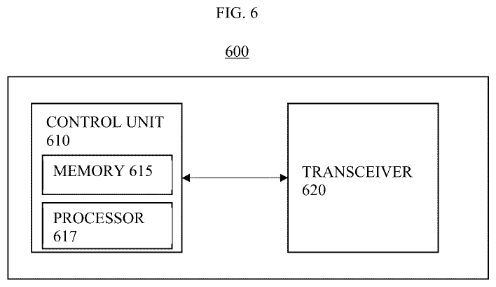

FIG. 6 is a block diagram of a user equipment, according to an embodiment.

The user equipment illustrated in FIG. 6 may be the first user equipment 140 or the second user equipment 145 described with respect to FIG. 1.

The user equipment 600 includes a control unit 610 and a transceiver 620.

The control unit 610 includes a memory 615 and processor 617. Although the user equipment 600 is illustrated as including the memory 615 and processor 617 in FIG. 6, the artisan of ordinary skill will appreciate that the user equipment 600 may include additional components for performing transmission and reception functions of the user equipment 600.

The memory 615 may be random access memory (RAM), solid state or flash memory, electrically erasable programmable read-only memory (EEPROM), or any other suitable data storage element for storing data and/or operating instructions, computer-readable codes, application programming, etc. of the user equipment 600. For example, the memory 615 may store an application for controlling operations of the lead user equipment or the member user equipment.

The processor 617 may be a central processing unit (CPU), microprocessor, or other suitable data processing element for controlling operations of the user equipment 105 by executing the operating instructions, computer-readable codes, application programming, etc. stored in the memory 615 of the user equipment 600.

The memory 615 and the processor 617 may communicate via one or more busses.

Although the memory 615 and processor 617 are illustrated as being embodied as separate components connected via a bus in FIG. 6, the artisan of ordinary skill will appreciate that the memory 615 and processor 617 may be integrated into a single component, such as an application-specific integrated circuit (ASIC) or other suitable electronic component for executing cellular transmission and reception functions of the user equipment 600.

The transceiver 620 may be communication circuitry configured to wirelessly communicate between the control unit 610 of the user equipment 600 and other entities of the cellular network, such as terrestrial network 110, the non-terrestrial network 120, or other user equipment 140, 145. The transceiver 620 may be configured to wirelessly communicate according to one or more cellular communication networks or protocols, such as 3G, 4G, LTE, 5G, 6G, GSM, GPRS, UMTS, CDMA, EDGE, and the like, as well as one or more local communication protocols, such as multi-hop vehicle-to-vehicle (V2V) via WiFi, ZigBee, LoRa, Sigfox, Bluetooth or 3GPP sidelink.

The transceiver 620 may include a control unit and an antenna. Although the transceiver 620 is described as including the control unit and antenna, the artisan of ordinary skill will appreciate that the transceiver 620 may include additional components for performing communication functions of the user equipment 600.

The antenna may be a multi-band mobile antenna configured to support one or more communication protocols adapted for wireless communication. The antenna may be an isotropic, omnidirectional, or other antenna structurally configured to wirelessly transmit or receive data over the communication network system.

### INDUSTRIAL APPLICABILITY

Embodiments of the present application are relevant for communication networks, and more particularly to provide for energy savings in the instance in which a plurality of user equipment may seek to simultaneously or substantially simultaneously establish a network connection by random access contention.

### REFERENCE SIGNS LIST

100 Communication Network
110 Terrestrial Network System
120 Non-Terrestrial Network System
130 Plurality of User Equipment
140 First User Equipment
145 Second User Equipment
600 User Equipment
610 Control Unit
620 Transceiver
615 Memory
617 Processor

1. A cellular network system comprising:
a network cell;
a first user equipment connected to the network cell; and
a second user equipment connected to the first user equipment via local communication protocol,
wherein the first user equipment is configured to request from the network cell a random access configuration of the second user equipment, and
wherein the first user equipment is configured to transmit the random access configuration to the second user equipment.

2. The cellular network system of claim 1, wherein the network cell comprises a network cell of a non-terrestrial network (NTN).

3. The cellular network system of claim 2, wherein the random access configuration comprises random access information for the second user equipment to perform random access to a terrestrial network (TN).

4. The cellular network system of claim 3, wherein the second user equipment comprises a plurality of user equipment.

5. The cellular network system of claim 4, wherein the first user equipment is configured to request from the network cell random access configurations of the plurality of user equipment based on a cell measurement report of the first user equipment.

6. The cellular network system of claim 4, wherein the first user equipment is configured to request from the network cell random access configurations of the plurality of user equipment based on cell measurement reports of the plurality of user equipment.

7. The cellular network system of claim 6, wherein the first user equipment is in an RRC_CONNECTED state connected to the network cell.

8. The cellular network system of claim 7, wherein the plurality of user equipment is in an RRC_INACTIVE state to the network cell.

9. The cellular network system of claim 8, wherein the first user equipment is configured to control the plurality of user equipment to obtain the cell measurement reports to perform random access to the terrestrial network (TN).

10. The cellular network system of claim 9, wherein the plurality of user equipment is configured to perform random access to the terrestrial network (TN) based on the random access information.

11. A user equipment comprising:
a transceiver; and
a control unit configured to control the transceiver to connect the user equipment to a network cell, control the transceiver to connect to a second user equipment via local communication protocol, control the transceiver to request from the network cell a random access configuration of the second user equipment, and control the transceiver to transmit the random access configuration to the second user equipment.

12. The user equipment of claim 11, wherein the network cell comprises a network cell of a non-terrestrial network (NTN).

13. The user equipment of claim 12, wherein the random access configuration comprises random access information for the second user equipment to perform random access to a terrestrial network (TN).

14. The user equipment of claim 13, wherein the second user equipment comprises a plurality of user equipment.

15. The user equipment of claim 14, wherein the control unit is configured to control the transceiver to request from the network cell random access configurations of the plurality of user equipment based on a cell measurement report of the user equipment.

16. The user equipment of claim 14, wherein the control unit is configured control the transceiver to request from the network cell random access configurations of the plurality of user equipment based on cell measurement reports of the plurality of user equipment.

17. The user equipment of claim 16, wherein the user equipment is in an RRC_CONNECTED state connected to the network cell.

18. The user equipment of claim 17, wherein the plurality of user equipment is in an RRC_INACTIVE state to the network cell.

19. The user equipment of claim 18, wherein the control unit is configured to control the plurality of user equipment to obtain the cell measurement reports to perform random access to the terrestrial network (TN).

20. The user equipment of claim 19, wherein the plurality of user equipment is configured to perform random access to the terrestrial network (TN) based on the random access information.

21. A user equipment comprising:
a transceiver; and
a control unit configured to control the transceiver to connect the user equipment to a relay user equipment connected to network cell via local communication protocol, control the transceiver to request from the relay user equipment a random access configuration of the user equipment, and control the transceiver to connect the user equipment to a cellular network system based on the random access configuration.

22. The user equipment of claim 21, wherein the network cell comprises a network cell of a non-terrestrial network (NTN).

23. The user equipment of claim 22, wherein the cellular network system comprises a terrestrial network (TN), and
wherein the random access configuration comprises random access information for the user equipment to perform random access to the terrestrial network (TN).

24. The user equipment of claim 23, wherein the user equipment comprises a user equipment among a plurality of user equipment connected to the relay user equipment as a group via the local communication protocol.

25. The user equipment of claim 24, wherein the control unit is configured to control the transceiver to request the random access information based on a cell measurement report of the relay user equipment.

26. The user equipment of claim 24, wherein the control unit is configured control the transceiver to perform a cell measurement report, and control the transceiver to request the random access information based on the cell measurement report.

27. The user equipment of claim 26, wherein the relay user equipment is in an RRC_CONNECTED state connected to the network cell.

28. The user equipment of claim 27, wherein the user equipment is in an RRC_INACTIVE state to the network cell.

29. The user equipment of claim 28, wherein the control unit is configured to control the transceiver to transmit the cell measurement report to the relay user equipment.

30. The user equipment of claim 29, wherein the control unit is configured to control the transceiver to perform random access to the terrestrial network (TN) based on the random access information.
